(19) United States
(12) Patent Application Publication
(10) Pub. No.: US 2020/0169655 A1
(43) Pub. Date: May 28, 2020

(54) IMAGING DEVICE AND PARAMETER ADJUSTING METHOD

(71) Applicant: QISDA CORPORATION, Taoyuan City (TW)

(72) Inventor: Min-Hsiung Huang, New Taipei City (TW)

(21) Appl. No.: 16/299,152

(22) Filed: Mar. 12, 2019

(30) Foreign Application Priority Data
Nov. 23, 2018 (CN) 201811408222.1

(51) Int. Cl. H04N 5/235; G06T 7/521

(52) U.S. Cl. CPC H04N 5/2351; H04N 5/238; H04N 5/2353; G06T 7/521

(57) ABSTRACT

An imaging device includes a projection unit, an image sensing unit and a processing unit. The projection unit is controlled by a projection parameter to project a light onto an object, wherein the light forms two color blocks on the object. The image sensing unit is controlled by an image capturing parameter to capture an image of the object, wherein the image includes the two color blocks. The processing unit analyzes the image to calculate a contrast ratio of the two color blocks. The processing unit compares the contrast ratio with a predetermined threshold. When the contrast ratio is larger or smaller than the predetermined threshold, the processing unit selectively adjusts at least one of the projection parameter and the image capturing parameter. The processing unit controls the projection unit to project the light onto the object and controls the image sensing unit to capture the image of the object.

### BACKGROUND OF THE INVENTION

### 1. Field of the Invention

The invention relates to an imaging device and a parameter adjusting method and, more particularly, to an imaging device and a parameter adjusting method capable of improving image quality effectively.

### 2. Description of the Prior Art

An intraoral scanner uses laser to scan tooth rapidly and then transmits the scanned image to a computer, so as to establish a tooth model. In general, the light intensity projected by the intraoral scanner is constant during the process of scanning tooth. However, different tissues or substances in an oral cavity may absorb or reflect different amounts of light and different materials filled in the tooth may also have different characteristics. Accordingly, during the process of scanning tooth, the projected brightness at some positions may be high and the projected brightness at some other positions may be low, such that the image quality will be affected. Furthermore, the length of the exposure time of an image sensor may also affect the image quality.

### SUMMARY OF THE INVENTION

An objective of the invention is to provide an imaging device and a parameter adjusting method capable of improving image quality effectively, so as to solve the aforesaid problems.

According to an embodiment of the invention, an imaging device comprises a projection unit, an image sensing unit and a processing unit, wherein the processing unit is electrically connected to the projection unit and the image sensing unit. The projection unit is controlled by a projection parameter to project a light onto an object, wherein the light forms two color blocks on the object. The image sensing unit is controlled by an image capturing parameter to capture an image of the object, wherein the image comprises the two color blocks. The processing unit analyzes the image to calculate a contrast ratio of the two color blocks. The processing unit compares the contrast ratio with a predetermined threshold. The processing unit selectively adjusts at least one of the projection parameter and the image capturing parameter when the contrast ratio is larger or smaller than the predetermined threshold. The processing unit controls the projection unit to project the light onto the object and controls the image sensing unit to capture the image of the object.

According to another embodiment of the invention, a parameter adjusting method is adapted to an imaging device. The imaging device comprises a projection unit and an image sensing unit. The parameter adjusting method comprises steps of controlling the projection unit by a projection parameter to project a light onto an object, wherein the light forms two color blocks on the object; controlling an image sensing unit by an image capturing parameter to capture an image of the object, wherein the image comprises the two color blocks; analyzing the image to calculate a contrast ratio of the two color blocks; comparing the contrast ratio with a predetermined threshold; and selectively adjusting at least one of the projection parameter and the image capturing parameter when the contrast ratio is larger or smaller than the predetermined threshold.

As mentioned in the above, the invention utilizes the contrast ratio of two color blocks projected onto the object to determine whether at least one of the projection parameter and the image capturing parameter needs to be adjusted. When the contrast ratio of the two color blocks is larger or smaller than the predetermined threshold, it means that the image quality generated by the imaging device is affected by the projection parameter and/or the image capturing parameter to get worse. At this time, the invention selectively adjusts at least one of the projection parameter and the image capturing parameter to improve the image quality. It should be noted that when the contrast ratio of the two color blocks conforms to the predetermined threshold, it means that the image quality generated by the imaging device is acceptable. At this time, the invention needs not to adjust the projection parameter and the image capturing parameter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating that an imaging device is scanning an object according to an embodiment of the invention.

FIG. 2 is a functional block diagram illustrating the imaging device shown in FIG. 1.

FIG. 3 is a schematic diagram illustrating an image captured by the image sensing unit shown in FIG. 2.

FIG. 4 is a schematic diagram illustrating a plurality of patterns stored in the storage unit shown in FIG. 2.

FIG. 5 is a flowchart illustrating a parameter adjusting method according to an embodiment of the invention.

### DETAILED DESCRIPTION

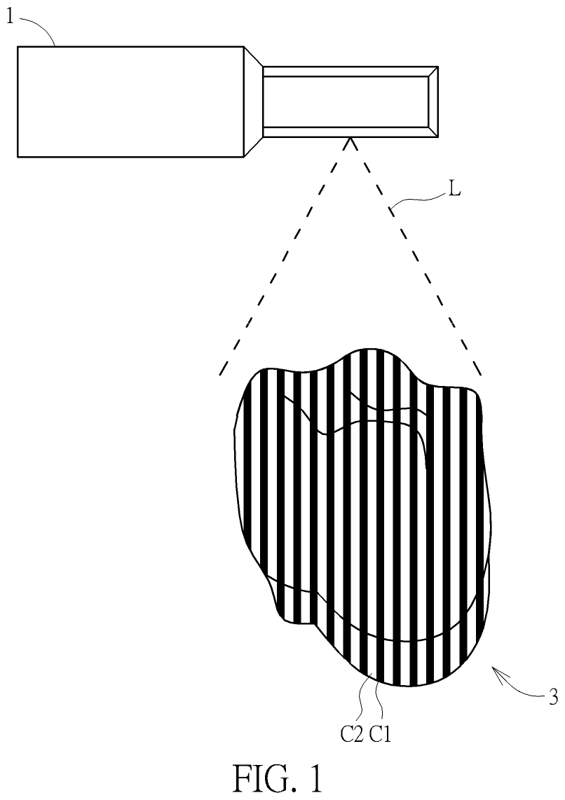

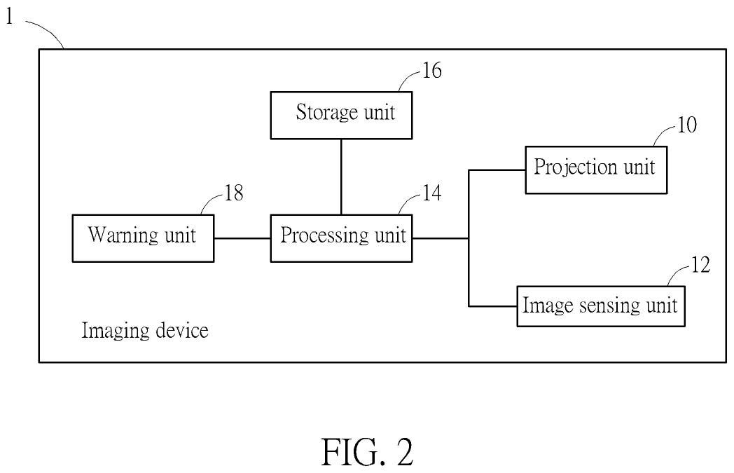

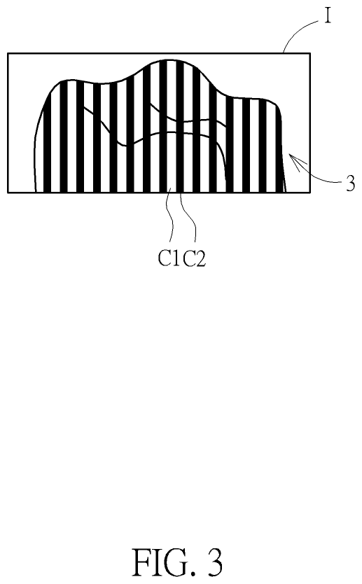

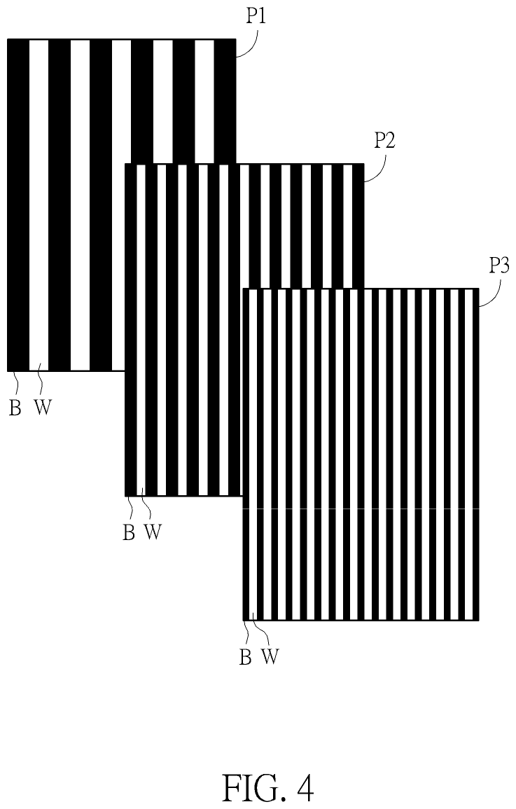

Referring to FIGS. 1 to 4, FIG. 1 is a schematic diagram illustrating that an imaging device 1 is scanning an object 3 according to an embodiment of the invention, FIG. 2 is a functional block diagram illustrating the imaging device 1 shown in FIG. 1, FIG. 3 is a schematic diagram illustrating an image I captured by the image sensing unit 12 shown in FIG. 2, and FIG. 4 is a schematic diagram illustrating a plurality of patterns P1-P3 stored in the storage unit 16 shown in FIG. 2.

As shown in FIG. 1, the imaging device 1 of the invention is used to scan an object 3, so as to establish a 3D model of the object 3. In this embodiment, the imaging device 1 may be, but not limited to, an intraoral scanner and the object 3 may be, but not limited to, a tooth. In another embodiment, the imaging device 1 may be a projection screen and the object 3 may be a projection plane. In another embodiment, the imaging device 1 may be a 3D model establishing device and the object 3 may be any object.

As shown in FIG. 2, the imaging device 1 comprises a projection unit 10, an image sensing unit 12, a processing unit 14, a storage unit 16 and a warning unit 18, wherein the processing unit 14 is electrically connected to the projection unit 10, the image sensing unit 12, the storage unit 16 and the warning unit 18. In practical applications, the projection unit 10 may be a digital light processing (DLP) module or other projection modules; the image sensing unit 12 may be a charge-coupled device (CCD) sensor, a complementary metal-oxide semiconductor (CMOS) sensor or other sensors; the processing unit 14 may be a processor or a controller with data processing/calculating function; the storage unit 16 may be a memory or other data storage devices; and the warning unit 18 may be an alarm capable of sending out a warning message including image, text, light, sound, or a combination thereof. In general, the imaging device 1 may be further equipped with some necessary hardware or software components for specific purposes, such as a circuit board, applications, a communication module, a power supply, etc., and it depends on practical applications.

In this embodiment, the storage unit 16 may store a plurality of patterns P1-P3 and each of the patterns P1-P3 comprises a plurality of black stripes B and a plurality of white stripes W, as shown in FIG. 4. The processing unit 14 may control the projection unit 10 to project the patterns P1-P3 onto the object 3 by a predetermined frequency and control the image sensing unit 12 to capture a plurality of images of the object 3 including the patterns P1-P3. Then, the processing unit 14 analyzes the images to establish a 3D model of the object 3 according to the variation of the patterns P1-P3.

As shown in FIG. 1, when the imaging device 1 is scanning the object 3, the projection unit 10 is controlled by a projection parameter to project a light L onto the object 3, wherein the light L forms two color blocks C1, C2 on the object 3. Then, the image sensing unit 12 is controlled by an image capturing parameter to capture an image I of the object 3. At this time, the image I comprises the two color blocks C1, C2, as shown in FIG. 3. In this embodiment, the projection parameter may comprise at least one of brightness and contrast, and the image capturing parameter may comprise at least one of exposure time, aperture size, ISO sensitivity, white balance and exposure compensation according to practical applications. Furthermore, the two color blocks C1, C2 maybe a thinnest black stripe B and a thinnest white stripe W of the patterns P1-P3. In this embodiment, since the black stripe B and the white stripe W of the pattern P3 are the thinnest, the two color blocks C1, C2 may be the black stripe B and the white stripe W of the pattern P3.

Then, the processing unit 14 analyzes the image I to calculate a contrast ratio of the two color blocks C1, C2. Then, the processing unit 14 compares the contrast ratio of the two color blocks C1, C2 with a predetermined threshold, wherein the predetermined threshold may be a value or a range. When the contrast ratio of the two color blocks C1, C2 is larger or smaller than the predetermined threshold, it means that the image quality generated by the imaging device 1 is affected by the projection parameter and/or the image capturing parameter to get worse. At this time, the processing unit 14 selectively adjusts at least one of the projection parameter and the image capturing parameter to improve the image quality. The processing unit 14 may decrease at least one of the projection parameter and the image capturing parameter when the contrast ratio of the two color blocks C1, C2 is larger than the predetermined threshold. The processing unit 14 may increase at least one of the projection parameter and the image capturing parameter when the contrast ratio of the two color blocks C1, C2 is smaller than the predetermined threshold.

After adjusting at least one of the projection parameter and the image capturing parameter, the processing unit 14 controls the projection unit 10 to project the light L onto the object 3 and controls the image sensing unit 12 to capture the image I of the object 3 again. In this embodiment, the processing unit 14 may adjust at least one of the projection parameter and the image capturing parameter gradually by a predetermined ratio (e.g. 1%, 3%, etc.) and compare the contrast ratio of the two color blocks C1, C2 with the predetermined threshold after adjustment every time. When the contrast ratio of the two color blocks C1, C2 conforms to the predetermined threshold after adjustment, it means that the image quality generated by the imaging device 1 is acceptable. At this time, the processing unit 14 needs not to adjust the projection parameter and the image capturing parameter accordingly.

It should be noted that when the predetermined threshold is a value, the contrast ratio of the two color blocks C1, C2 equal to the value means that the contrast ratio of the two color blocks C1, C2 conforms to the predetermined threshold; and when the predetermined threshold is a range, the contrast ratio of the two color blocks C1, C2 falling within the range means that the contrast ratio of the two color blocks C1, C2 conforms to the predetermined threshold.

The aforesaid predetermined threshold may be determined according to practical applications. For example, the invention may take a contrast ratio of two color blocks C1, C2 corresponding to a system default projection parameter and a system default image capturing parameter to be a predetermined threshold value or, alternatively, add/subtract an acceptable value to/from a contrast ratio of two color blocks C1, C2 corresponding to a system default projection parameter and a system default image capturing parameter to be a predetermined threshold range.

In this embodiment, the processing unit 14 may selectively adjust at least one of the projection parameter and the image capturing parameter according to a predetermined adjusting sequence. For example, when the projection parameter comprises brightness and contrast and the image capturing parameter comprises exposure time, aperture size, ISO sensitivity, white balance and exposure compensation, the predetermined adjusting sequence may be represented by exposure time, aperture size, exposure compensation, brightness, contrast, ISO sensitivity, and white balance in sequence. It should be noted that the predetermined adjusting sequence may be determined according to the types of the projection parameter and the image capturing parameter, so the predetermined adjusting sequence is not limited to the aforesaid embodiment. As to the principles of adjusting exposure time, aperture size, exposure compensation, brightness, contrast, ISO sensitivity, and white balance, those are well known by one skilled in the art, so those will not depicted herein in detail .

When the processing unit 14 adjusts at least one of the projection parameter and the image capturing parameter to a limit value and the contrast ratio of the two color blocks C1, C2 is still larger or smaller than the predetermined threshold, the processing unit 14 may control the warning unit 18 to send out a warning message (e.g. image, text, light, sound, or a combination thereof), so as to inform a user that the optimal image quality cannot be obtained. At this time, the processing unit 14 may control the projection unit 10 and the image capturing unit 12 by current or system default projection parameter and image capturing parameter.

In another embodiment, the two color blocks C1, C2 mentioned in the above may be other color blocks different from the black stripe B and the white stripe W. At this time, a width of one of the two color blocks C1, C2 may be smaller than or equal to a width of a thinnest black stripe B of the patterns P1-P3, and a width of another one of the two color blocks C1, C2 may be smaller than or equal to a width of a thinnest white stripe W of the patterns P1-P3. Furthermore, in addition to black and white, the two color blocks C1, C2 may also be other colors according to practical applications.

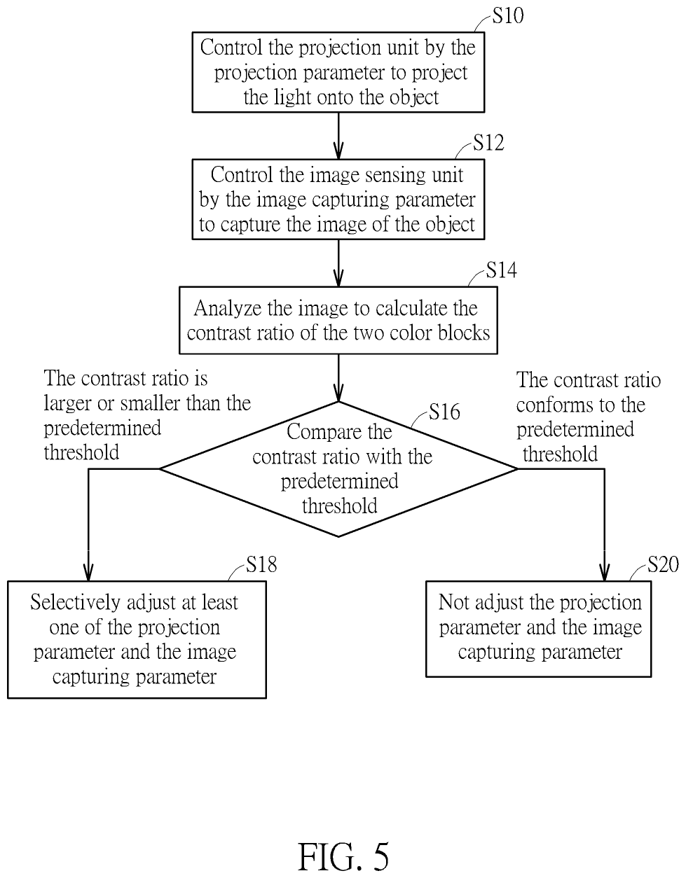

Referring to FIG. 5, FIG. 5 is a flowchart illustrating a parameter adjusting method according to an embodiment of the invention. The parameter adjusting method shown in FIG. 5 can be implemented by the aforesaid imaging device 1. First, step S10 is performed to control the projection unit 10 by the projection parameter to project the light L onto the object 3. Then, step S12 is performed to control the image sensing unit 12 by the image capturing parameter to capture the image I of the object 3. Then, step S14 is performed to analyze the image I to calculate the contrast ratio of the two color blocks C1, C2. Then, step S16 is performed to compare the contrast ratio of the two color blocks C1, C2 with the predetermined threshold. When the contrast ratio of the two color blocks C1, C2 is larger or smaller than the predetermined threshold, step S18 is performed to selectively adjust at least one of the projection parameter and the image capturing parameter. When the contrast ratio of the two color blocks C1, C2 conforms to the predetermined threshold, step S20 is performed to not adjust the projection parameter and the image capturing parameter.

It should be noted that the detailed embodiments of the parameter adjusting method of the invention are mentioned in the above and those will not be depicted herein again. Furthermore, each part or function of the control logic of the parameter adjusting method shown in FIG. 5 may be implemented by software, hardware or the combination thereof.

As mentioned in the above, the invention utilizes the contrast ratio of two color blocks projected onto the object to determine whether at least one of the projection parameter and the image capturing parameter needs to be adjusted. When the contrast ratio of the two color blocks is larger or smaller than the predetermined threshold, it means that the image quality generated by the imaging device is affected by the projection parameter and/or the image capturing parameter to get worse. At this time, the invention selectively adjusts at least one of the projection parameter and the image capturing parameter to improve the image quality. It should be noted that when the contrast ratio of the two color blocks conforms to the predetermined threshold, it means that the image quality generated by the imaging device is acceptable. At this time, the invention needs not to adjust the projection parameter and the image capturing parameter.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An imaging device comprising:
a projection unit controlled by a projection parameter to project a light onto an object, the light forming two color blocks on the object;
an image sensing unit controlled by an image capturing parameter to capture an image of the object, the image comprising the two color blocks; and
a processing unit electrically connected to the projection unit and the image sensing unit, the processing unit analyzing the image to calculate a contrast ratio of the two color blocks, the processing unit comparing the contrast ratio with a predetermined threshold, the processing unit selectively adjusting at least one of the projection parameter and the image capturing parameter when the contrast ratio is larger or smaller than the predetermined threshold, the processing unit controlling the projection unit to project the light onto the object and controlling the image sensing unit to capture the image of the object.

2. The imaging device of claim 1, wherein the processing unit selectively adjusts at least one of the projection parameter and the image capturing parameter according to a predetermined adjusting sequence when the contrast ratio is larger or smaller than the predetermined threshold.

3. The imaging device of claim 1, wherein the processing unit decreases at least one of the projection parameter and the image capturing parameter when the contrast ratio is larger than the predetermined threshold; and the processing unit increases at least one of the projection parameter and the image capturing parameter when the contrast ratio is smaller than the predetermined threshold.

4. The imaging device of claim 1, further comprising a storage unit electrically connected to the processing unit, the storage unit storing a plurality of patterns, each of the patterns comprising a plurality of black stripes and a plurality of white stripes, the two color blocks being a thinnest black stripe and a thinnest white stripe of the patterns.

5. The imaging device of claim 1, further comprising a storage unit electrically connected to the processing unit, the storage unit storing a plurality of patterns, each of the patterns comprising a plurality of black stripes and a plurality of white stripes, a width of one of the two color blocks being smaller than or equal to a width of a thinnest black stripe of the patterns, a width of another one of the two color blocks being smaller than or equal to a width of a thinnest white stripe of the patterns.

6. The imaging device of claim 1, further comprising a warning unit electrically connected to the processing unit, the processing unit controlling the warning unit to send out a warning message when the processing unit adjusts at least one of the projection parameter and the image capturing parameter to a limit value and the contrast ratio is still larger or smaller than the predetermined threshold.

7. The imaging device of claim 1, wherein the projection parameter comprises at least one of brightness and contrast, and the image capturing parameter comprises at least one of exposure time, aperture size, ISO sensitivity, white balance and exposure compensation.

8. A parameter adjusting method adapted to an imaging device, the imaging device comprising a projection unit and an image sensing unit, the parameter adjusting method comprising steps of:
controlling the projection unit by a projection parameter to project a light onto an object, wherein the light forms two color blocks on the object;
controlling an image sensing unit by an image capturing parameter to capture an image of the object, wherein the image comprises the two color blocks;
analyzing the image to calculate a contrast ratio of the two color blocks;
comparing the contrast ratio with a predetermined threshold; and
selectively adjusting at least one of the projection parameter and the image capturing parameter when the contrast ratio is larger or smaller than the predetermined threshold.

9. The parameter adjusting method of claim 8, wherein the parameter adjusting method selectively adjusts at least one of the projection parameter and the image capturing parameter according to a predetermined adjusting sequence when the contrast ratio is larger or smaller than the predetermined threshold.

10. The parameter adjusting method of claim 8, wherein the parameter adjusting method decreases at least one of the projection parameter and the image capturing parameter when the contrast ratio is larger than the predetermined threshold; and the parameter adjusting method increases at least one of the projection parameter and the image capturing parameter when the contrast ratio is smaller than the predetermined threshold.

11. The parameter adjusting method of claim 8, wherein the two color blocks are a thinnest black stripe and a thinnest white stripe of a plurality of patterns.

12. The parameter adjusting method of claim 8, wherein a width of one of the two color blocks is smaller than or equal to a width of a thinnest black stripe of a plurality of patterns, and a width of another one of the two color blocks is smaller than or equal to a width of a thinnest white stripe of the patterns.

13. The parameter adjusting method of claim 8, further comprising step of:
sending out a warning message when at least one of the projection parameter and the image capturing parameter is adjusted to a limit value and the contrast ratio is still larger or smaller than the predetermined threshold.

14. The parameter adjusting method of claim 8, wherein the projection parameter comprises at least one of brightness and contrast, and the image capturing parameter comprises at least one of exposure time, aperture size, ISO sensitivity, white balance and exposure compensation.
